(19) United States
(12) Patent Application Publication
(10) Pub. No.: US 2005/0265576 A1
(43) Pub. Date: Dec. 1, 2005

(54) Video watermarking method and apparatus, and video content protecting method and apparatus using video watermarking

(75) Inventors: Yeong-kyeong Seong, Seoul (KR); Yoon-hee Choi, Daejeon (KR); Tae-sun Choi, Gwangju (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/062,549

(22) Filed: Feb. 23, 2005

(30) Foreign Application Priority Data
May 27, 2004 (KR) 10-2004-0037756

(51) Int. Cl. G06K 9/00; G06K 9/36

(52) U.S. Cl. 382/100; 382/232

(57) ABSTRACT

Provided are a video watermarking method and apparatus and a video content protecting method and apparatus using video watermarking. The method includes detecting scene transition in a video sequence, calculating an image complexity in a scene using one or more frames included in the scene and determining a watermark embedding strength for the scene, and embedding a watermark into the video sequence according to the watermark embedding strength.

### CROSS-REFERENCE TO RELATED APPLICATION

This application claims priority from Korean Patent Application No. 10-2004-0037756 filed on May 27, 2004, in the Korean Intellectual Property Office, the disclosure of which is incorporated herein in its entirety by reference.

### BACKGROUND OF THE INVENTION

1. Field of the Invention

The present invention relates to video watermarking, and more particularly, to a video watermarking method and apparatus and a video content protecting method and apparatus using video watermarking.

2. Description of the Related Art

With the development of digital technology, a huge amount of digital media data has been able to be easily used. Unlike analog information, digital information can be copied in large quantities without quality deterioration at a low cost. These features of digital information may cause a problem in view of copyright protection. To protect the copyright on digital content, digital watermarking has been discussed.

In a watermarking technique, a user's identification (ID) or unique information is embedded into digital content, thereby preventing an illegal copy of the digital content, protecting copyright on the digital content, and providing authorization on making claim to the digital content.

The watermarking technique needs to satisfy the following conditions to prove ownership against an illegal copy or distribution and to properly function against attacks of removing a watermark.

Invisibility

After a watermark is embedded, original content should rarely change, and the embedding of the watermark should not be perceived. Invisibility is a feature of a watermark for prevention of content quality deterioration. An embedded watermark should not be shown visually. In some applications, visible watermarking techniques are used. Meanwhile, invisibility is referred to as imperceptibility in the case of normal, non-image content.

Robustness

When a signal including a watermark is compressed for transmission or storage, the watermark should not be broken. In addition, even if the signal including the watermark has experienced noise, various modifications, or attacks during transmission, the watermark should be able to be extracted. These features are related to robustness. However, in some applications, fragile watermarking techniques are intentionally used mainly for authentication. When a semi-fragile technique watermarking technique is used, a location of illegal operation can be accurately detected.

Unambiguity

A watermark should preserve its explicitness against attacks so that the extracted watermark can provide authorization to claiming ownership.

Blindness

A watermark should be detected using only a watermarked image without an original image. This feature is necessary in consideration of the reality in which a right owner must be identifiable when a watermarking technique is used online or in various applications.

Security

A watermark should be verifiable using a related key value.

Besides, many other conditions including capacity of embedded information and multiple watermarking need to be satisfied.

Meanwhile, recently, a new platform in which a hard disk is included in a digital broadcast receiving unit has been introduced. A user can privately store a television broadcast for time-shift play using such equipment. This act is allowable at present. However, once stored, broadcast data must not be copied to another device due to copyright protection.

A watermarking technique may be used in embedding copy protection information into stored broadcast data and detecting the copy protection information. For example, let's define “copy never” and “copy freely” as copy protection information embedded in the form of a watermark. When broadcast data includes “copy never,” the broadcast data is protected from being copied to another device. When the broadcast data includes “copy freely,” it is allowed to be copied to another device. In other words, a digital broadcast receiving unit checks the copy protection information included in the broadcast data and protects the broadcast data from being copied to another device such as a computer or a personal video recorder (PVR) when the copy protection information is “copy never.”

A real time (or semi-real time) watermarking method is needed for a digital broadcast program or a movie provided through video-on-demand (VOD) service. Many approaches for implementing real time video watermarking have been proposed. For example, G. C. Langelaar et al., introduced a method of embedding a watermark by changing a variable length coding (VLC) codeword within a compression domain in “Watermarking Digital Image and Video Data.” However, when a watermark is embedded into a VLC domain, it is vulnerable to illegal attacks. M. K. Swanson proposed a watermark per scene based on multiresolution video analysis in “Multiresolution Scene-Based Video Watermarking Using Perceptual Models.” In this proposal, a video sequence is divided into scenes, and temporal wavelet transform is performed on each scene. However, this proposal is disadvantageous in that it is very difficult to realize real time processing due to computational complexity.

Accordingly, real time video watermarking with less computation is highly in demand.

### SUMMARY OF THE INVENTION

The present invention provides a real time (or semi-real time) video watermarking method and apparatus with high computational efficiency.

The present invention also provides a video content protecting method and apparatus using real time video watermarking.

These and other aspects of the present invention will be apparent from the detailed description that follows.

According to an aspect of the present invention, there is provided a video watermarking method including detecting scene transition in a video sequence, calculating an image complexity in a scene using one or more frames included in the scene and determining a watermark embedding strength for the scene, and embedding a watermark into the video sequence according to the watermark embedding strength.

According to another aspect of the present invention, there is provided a video watermarking method comprising detecting scene transition in a video sequence, calculating an image complexity in a scene using one or more frames included in the scene and obtaining a first coefficient used to determine a watermark embedding strength for the scene, obtaining a second coefficient used to determine a watermark embedding strength according to a motion vector size of an inter-frame in the video sequence, and embedding a watermark into the video sequence with respect to an intra-frame according to the watermark embedding strength determined using the first coefficient and embedding the watermark into the video sequence with respect to an inter-frame according to a watermark embedding strength determined using the first coefficient and second coefficient.

According to still another aspect of the present invention, there is provided a video watermarking apparatus including a scene transition detector detecting scene transition in a video sequence, an image complexity calculator calculating an image complexity in a scene using one or more frames included in the scene, and a watermark embedder determining a watermark embedding strength using the image complexity and embedding a watermark into the video sequence according to the watermark embedding strength.

According to a further aspect of the present invention, there is provided a video content protecting method comprising determining a watermark message to be included in a watermark according to an authorization on an input video sequence, determining a watermark embedding strength for each of scenes included in the video sequence using an image complexity of a first intra-frame in each scene, embedding a watermark into the video sequence according to the watermark embedding strength, and detecting the watermark embedded in the video sequence and managing the video sequence according to the watermark message included in the watermark.

According to a further aspect of the present invention, there is provided a video content protecting apparatus comprising a message determiner determining a watermark message to be included in a watermark according to an authorization on an input video sequence, a watermark embedder detecting scene transition in the video sequence, determining a watermark embedding strength for each of the scenes included in the video sequence using an image complexity of a first intra-frame in each scene, and embedding a watermark into the video sequence according to the watermark embedding strength, a watermark detector detecting the watermark embedded in the video sequence, and a video content management unit managing the video sequence according to the watermark message included in the watermark.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a broadcast receiving system having a copy protection feature according to an exemplary embodiment of the present invention;

FIG. 2 is a block diagram of a watermark embedding device according to an exemplary embodiment of the present invention;

FIG. 3 is a detailed block diagram of a watermark embedder according to an exemplary embodiment of the present invention;

FIG. 4 is a flowchart of a method of embedding a watermark according to an exemplary embodiment of the present invention;

FIGS. 5A through 5C illustrate a procedure for detecting scene transition according to an exemplary embodiment of the present invention;

FIGS. 6A and 6B illustrate a parameter determining a watermark embedding strength according to an exemplary embodiment of the present invention;

FIG. 7 illustrates an application of watermarking to a video sequence according to an exemplary embodiment of the present invention;

FIGS. 8A and 8B illustrate experiment results with respect to image complexity and frame area division according to motion vector sizes in an exemplary embodiment of the present invention; and

FIGS. 9A through 9F illustrate results of detecting a watermark according to an exemplary embodiment of the present invention when a watermarked image is attacked in various ways.

### DETAILED DESCRIPTION OF THE INVENTION

Hereinafter, exemplary embodiments of the present invention will be described in detail with reference to the attached drawings.

Exemplary Embodiment of Application of Watermarking Method

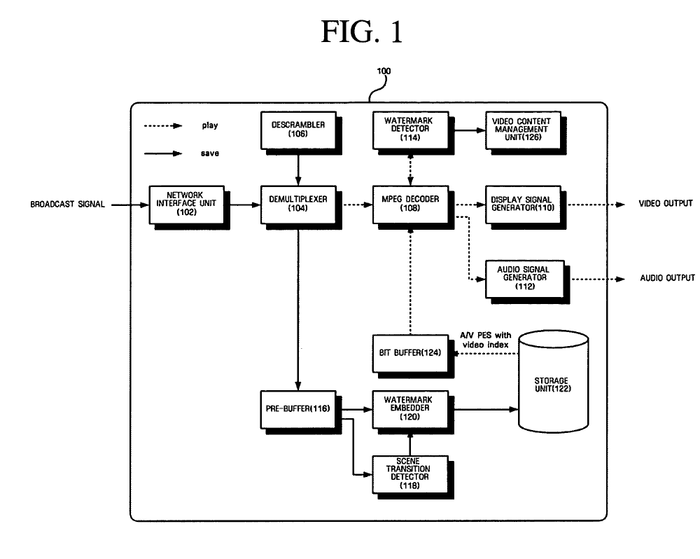

FIG. 1 is a block diagram of a broadcast receiving system 100 having a copy protection feature according to an exemplary embodiment of the present invention.

The broadcast receiving system 100 receives a broadcast signal coded in accordance with Motion Picture Experts Group (MPEG) standards and decodes the broadcast signal to play broadcast content.

A network interface unit 102 demodulates the broadcast signal to convert it into a digital signal which may include a plurality of programs. A demultiplexer 104 extracts a program selected by a user from the digital signal into which the plurality of programs are multiplexed. Meanwhile, a pay-per-view program is scrambled so that only subscribers can view the program. A descrambler 106 descrambles the scrambled program.

The demultiplexed and descrambled program is decoded by an MPEG decoder 108. Decoded video information is output as a video signal by a video signal generator 110 and decoded audio information is output as an audio signal by an audio signal generator 112.

The broadcast receiving system 100 stores the received program in a storage unit 122 that is a non-volatile storage medium such as a hard disk so that a user can view the program any time other than a real broadcast time. A user having a proper authorization on a program is permitted to temporarily or permanently store the program and play it. However, copying the program from the broadcast receiving system 100 to another device may cause a copyright problem.

Accordingly, the broadcast receiving system 100 may embed additional information to a program when the program is stored to limit access to the program according to an authorization on the program. In the exemplary embodiment of the present invention, a watermark indicating an authorization on a broadcast program is embedded into the broadcast program as the additional information. For example, a watermark indicating “copy never” is embedded into a scrambled pay-per-view program while a watermark indicating “copy freely” is embedded into a program that is available to be copied freely. If an authorization on a program is limited to playing the program three times, a watermark indicating “three playbacks” is embedded into the program. If the program limited to three playbacks has been played once, a watermark indicating “two playbacks” is newly embedded into the program. Meanwhile, a unique key of the broadcast receiving system 100 may be included in the watermark so that a person who infringes copyright can be identified when infringement of copyright such as an illegal copy occurs.

Watermarking a broadcast program needs to be performed in real time or in semi-real time. Real time watermarking needs much time for computation. In other words, when a watermark embedding strength is calculated for each of all frames in a motion picture program, a huge amount of computation is needed. However, in the present invention, scene transition is detected, and a watermark embedding strength is determined per scene. For this operation, a scene transition detector 118 determines whether the demultiplexed program has scene transition. Thereafter, a watermark embedder 120 embeds a watermark into the demultiplexed program temporarily stored in a pre-buffer 116. The watermarked program is stored in the storage unit 122.

To execute the watermarked program, it must be stored in a bit buffer 124 and then decoded by the MPEG decoder 108. Here, a watermark detector 114 detects the watermark embedded into the program. A message included in the detected watermark is transmitted to a video content management unit 126. If playback of the program is not allowed any more, the video content management unit 126 prevents the broadcast receiving system 100 from playing the program. If the program is allowed to be played, the video content management unit 126 does not prevent the broadcast receiving system 100 from playing the program. Meanwhile, when the program is copied to another device, the video content management unit 126 prevents the program from being copied from the broadcast receiving system 100 to another device if the program is copy protected.

In the exemplary embodiment of the present invention, the broadcast receiving system 100 inserts a unique message to a watermark. In this case, if a user illegally modifies the broadcast receiving system 100 and copies a copy-protected program from the broadcast receiving system 100 to another device, the user can be identified by detecting a watermark embedded into the illegally copied program.

In the exemplary embodiment of the present invention, a broadcast receiving system has been explained as an apparatus which can protect video content using watermarking. However, it will be construed that any type of apparatus that protect video content using watermarking is included in the scope of the present invention.

Watermark Embedding Device

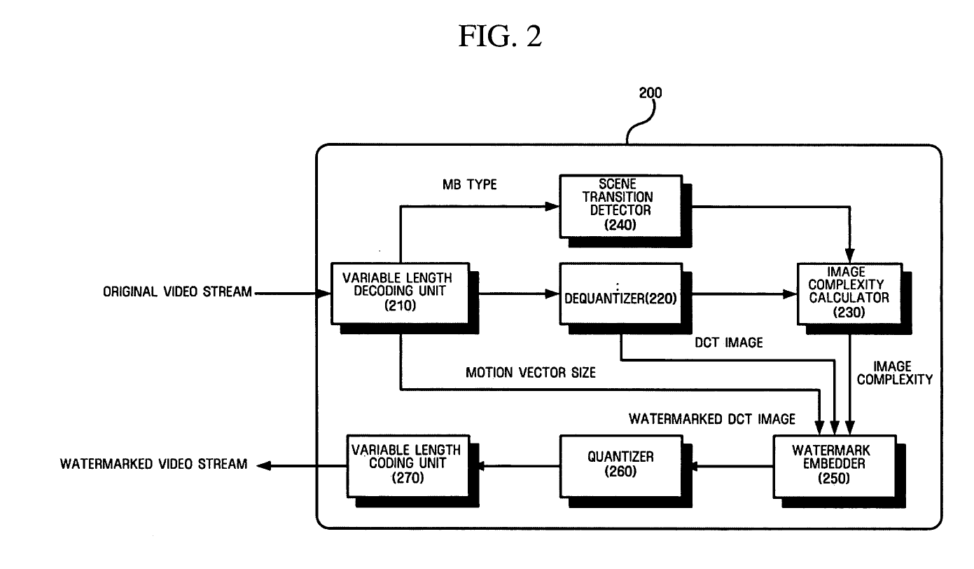

FIG. 2 is a block diagram of a watermark embedding device 200 according to an exemplary embodiment of the present invention. In the exemplary embodiment of the present invention, watermarking a discrete cosine transform (DCT) coded video stream will be exampled.

The watermark embedding device 200 receives an original video stream that has been coded using DCT coding, for example, MPEG-2 coding, and outputs a watermarked video stream.

Upon receiving the original video stream, a variable length decoding unit 210 variable length decodes the original video stream that has been variable length coded. Through the variable length decoding, macroblock (MB) type information, a motion vector, and a quantized DCT image can be obtained.

A scene transition detector 240 determines whether the video stream includes scene transition. In the exemplary embodiment of the present invention, whether the video stream includes scene transition is determined using an MB type, which will be described later. A result of determining an existence or non-existence of scene transition is transmitted to an image complexity calculator 230.

A dequantizer 220 dequantizes the quantized DCT image and outputs a DCT image.

The image complexity calculator 230 calculates a complexity of the DCT image. The calculated image complexity is transmitted to a watermark embedder 250 to be used in determining a watermark embedding strength. The image complexity is almost uniform throughout a single scene. Based on this characteristic, in the exemplary embodiment of the present invention, the image complexity of each scene is calculated using one or more frames representing the scene.

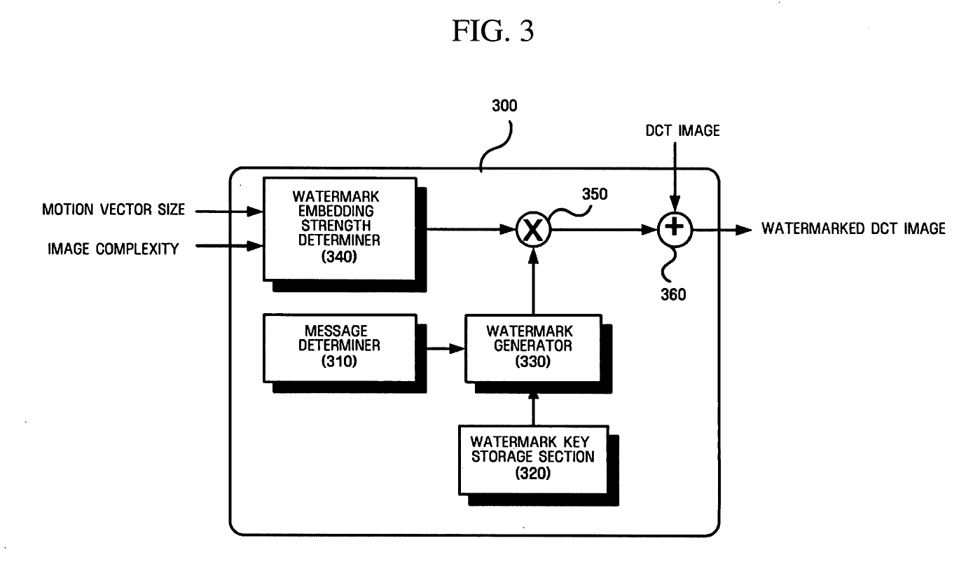

The watermark embedder 250 receives a motion vector size and the image complexity, determines a watermark embedding strength, and watermarks the DCT image according to the determined watermark embedding strength. The watermarked DCT image is quantized by a quantizer 260, is then variable length coded by a variable length coding unit 270, is then output as the watermarked video stream. The watermark embedder 250 will be described later with reference to FIG. 3.

The watermark embedding device 200 shown in FIG. 2 watermarks a video stream that has been coded according to an MPEG standard (e.g., an MPEG-2 or MPEG-4 standard). However, the present invention can also watermark video that has not been coded. In this case, watermarking is performed on a DCT image obtained when the video is coded according to the MPEG standard.

Watermarking an MPEG-coded video stream has been described with reference to FIG. 2, but is it just an example. In other words, according to another exemplary embodiment of the present invention, even with respect to a video stream that has been coded based on a wavelet, scene transition can be detected, image complexity in one or more representative frames of a scene can calculated, and a watermark embedding strength can be determined.

FIG. 3 is a detailed block diagram of a watermark embedder 300 according to an exemplary embodiment of the present invention.

A watermark embedder 300 includes a message determiner 310 determining a watermark message, a watermark key storage section 320 storing a watermark key that is a unique value of the watermark embedder 300, a watermark generator 330, a watermark embedding strength determiner 340, a multiplier 350, and an adder 360.

The message determiner 310 determines a watermark message to be included in a watermark. In the exemplary embodiment of the present invention, the watermark message included in the watermark is determined according to an authorization on video. For example, the watermark message may be “one playback” or “copy freely.”

The watermark generator 330 performs spectrum spreading on the watermark message using the watermark key to generate a watermark. For example, the watermark generator 330 performs a modulus operation on the watermark message and the watermark key.

The watermark embedding strength determiner 340 determines a watermark embedding strength based on a motion vector size and an image complexity. The determining of the watermark embedding strength will be described in detail later. The watermark is multiplied by the watermark embedding strength in the multiplier 350 and then added to a DCT image in the adder 360.

Embedding a Watermark

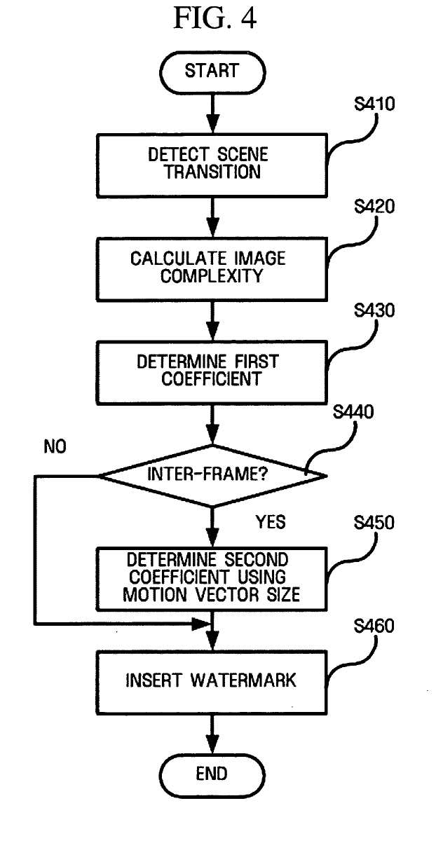

Embedding a watermark into a video sequence will be described with reference to FIG. 4.

Scene transition is detected in the video sequence in operation S410. Subsequently, an image complexity is calculated using one or more frames representing a scene in operation S420. A first coefficient used to determine a watermark embedding strength is determined using the image complexity in operation S430. Thereafter, it is determined whether each frame included in the scene is an inter-frame in operation S440. When a frame is determined as being the inter-frame, a second coefficient is determined using a motion vector size in operation S450. When the frame is the inter-frame, a watermark is inserted with a watermark embedding strength determined using the first and second coefficients in operation S460. However, when the frame is not the inter-frame, a watermark is inserted with a watermark embedding strength determined using the first coefficient in operation S460. The inter-frame means a frame that is coded referring to other frames in the video sequence. A P-frame or a B-frame defined in an MPEG video coding standard corresponds to the inter-frame. A frame that is not the inter-frame is an intra-frame, which is coded without referring to other frames. An I-frame defined in the MPEG video coding standard corresponds to the intra-frame.

Detecting Scene Transition

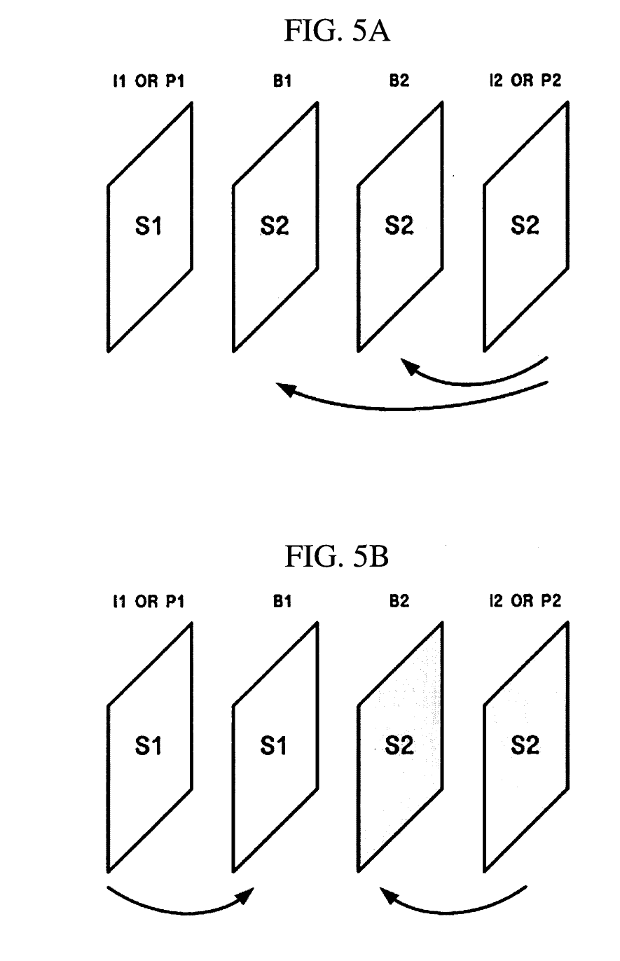

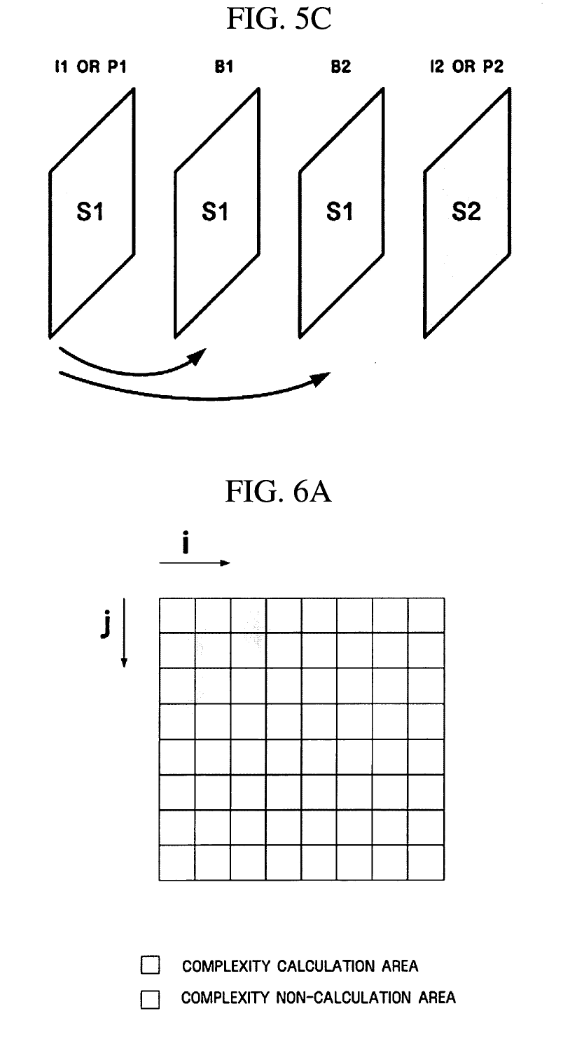

FIGS. 5A through 5C illustrate a procedure for detecting scene transition according to an exemplary embodiment of the present invention. To simplify calculation, an MB type for a B-frame is used in the procedure illustrated in FIGS. 5A through 5C.

As shown in FIG. 5A, when scene transition between scenes S1 and S2 occurs in a frame BI, most of MB types for frames B1 and B2 are subjected to backward motion compensation because the frame B1 is almost similar to a frame 12 or P2.

Referring to FIG. 5B, when scene transition between the scenes S1 and S2 occurs in the frame B2, most of MB types for the frame B1 are subjected to forward motion compensation and most of MB types for the frame B2 are subjected to backward motion compensation.

Referring to FIG. 5C, when scene transition between the scenes S1 and S2 occurs in the frame 12 or P2, most of the MB types for the frames B1 and B2 are subjected to forward motion compensation.

When scene transition does not occur, most of the MB types for the frames B1 and B2 shown in FIGS. 5A through 5C are not subjected to special motion compensation. In other words, existence or non-existence of scene transition can be easily determined by determining a direction of motion compensation for an MB type.

Watermark Embedding Strength

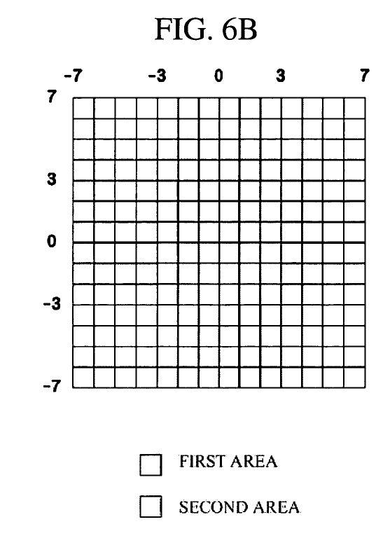

FIGS. 6A and 6B illustrate a parameter determining a watermark embedding strength according to an exemplary embodiment of the present invention.

Specifically, FIG. 6A illustrates a complexity calculation area in which image complexity is calculated, and FIG. 6B illustrates detecting a second coefficient using a motion vector size.

A watermark embedding strength is determined per scene. Image complexity in a scene is calculated using one or more frames representing the scene. For example, the image complexity is calculated using a first intra-frame included in the scene. FIG. 6A shows a DCT block of the first intra-frame in the scene. In the DCT block, a pixel (0,0) is a direct current (DC) component and is excluded from image complexity calculation. The image complexity is calculated using only an alternating current (AC) component. The image complexity may be calculated using all of the AC components. However, only some of the AC components are used in calculating the image complexity as shown in FIG. 6A. The image complexity may be determined in various manners. However, to simplify calculation, the image complexity is calculated using Equation (1) in the exemplary embodiment of the present invention.

$$IC = {\sum }_{( i , j ) ∈ A} \vert DCT ( i , j ) \vert \qquad ( 1 )$$

Here, IC denotes the image complexity, A denotes the complexity calculation area, and DCT(i,j) denotes a DCT coefficient of a pixel (i,j) in the DCT block. In FIG. 6A, A={(0,1), (0,2), (0,3), (1,0), (1,1), (1,2), (2,0), (2,1), (3,0)}.

With respect to a single scene, image complexities may be calculated in DCT blocks, respectively, included in a frame using Equation (1). However, a single image complexity may be calculated in the frame using Equation (2).

$$IC = {\sum }_{k = 1}^{n} {\sum }_{( i , j ) ∈ A} \vert {DCT}_{k} ( i , j ) \vert \qquad ( 2 )$$

Here, “k” denotes a DCT block number and “n” denotes the number of DCT blocks included in one frame.

After calculating the image complexity, a first coefficient α determining the watermark embedding strength is determined as follows:

If scene transition occurs,

Calculate image complexity (IC) ;
If (IC > Minimum complexity)

α = Constant × IC;

Else

α =Constant × Minimum complexity;

Else

Use previously calculated α

End

where, in case of an intra-frame, the watermark embedding strength can be determined using only the first coefficient α. However, in case of an inter-frame, the watermark embedding strength can be increased according to a motion vector size. FIG. 6B shows a motion vector size. In FIG. 6B, two areas are defined: a first area and a second area. In the first area, the motion vector size is small. In the second area, the motion vector size is large. If a motion vector is (4,5), it belongs to the second area. When the motion vector size is large, a large second coefficient is used as a second coefficient β. When the motion vector size is small, a small second coefficient is used as the second coefficient β. In other words, when the motion vector size is determined, the second coefficient β is calculated using Equation (3):
If |MV|≦T_{β}, β=β1 Else, β=β2 (3)
where β1 and β2 are second coefficients for the first and second areas, respectively, and a value of β2 is grater than a value of β1.

In FIG. 6B, only two areas are defined, but more areas may be defined.

After the first and second coefficients are determined, a watermarked DCT image may be determined by Equation (4):
I′=I{1+(α+β)W} (4)
where “I” denotes a coefficient of an image in a DCT area, and “I′” denotes a coefficient of a watermarked image in the DCT area. A changed coefficient in the DCT area is obtained using at least one AC component. “α” and “β” denote the first and second coefficients, respectively, and W denotes a watermark. In a case of an intra-frame, although a watermarked DCT image may be determined by Equation (4), the watermarked DCT image may be determined by Equation (5) using only the first coefficient. When Equation (4) is used in the case of the intra-frame, the second coefficient has a value of β1.
I′=I{1+αW} (5)

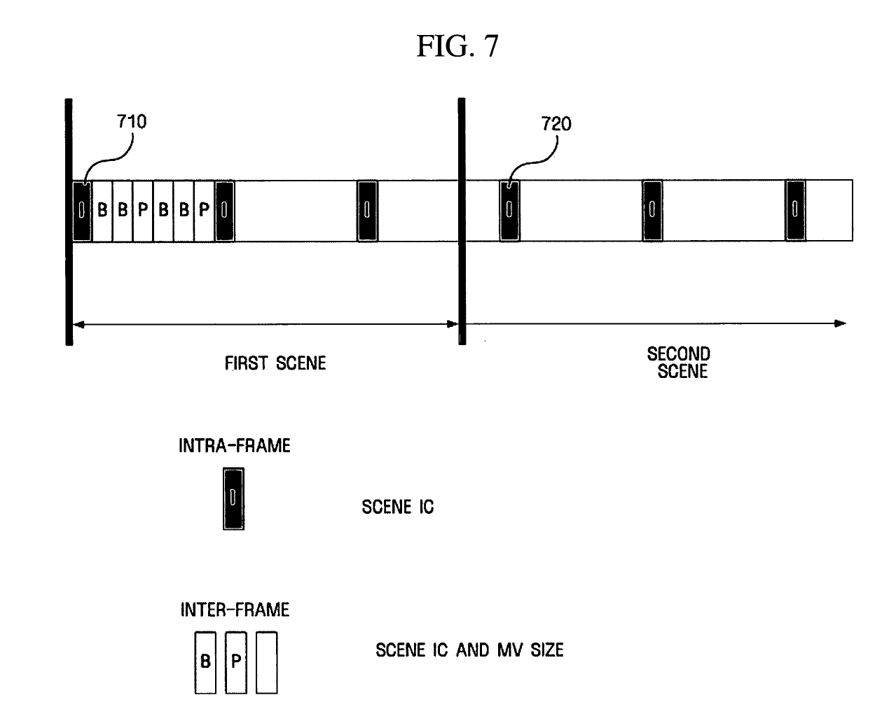

FIG. 7 illustrates an application of watermarking to a video sequence according to an exemplary embodiment of the present invention.

When transition between a first scene and a second scene is detected in a video sequence, an image complexity (IC) in the first scene is calculated using a first intra-frame 710 in the first scene, and an image complexity of the second scene is calculated using a first intra-frame 720 in the second scene.

With respect to an intra-frame in a scene, a watermark embedding strength can be determined using only an image complexity in the scene. However, with respect to an inter-frame in a scene, both of an image complexity in the scene and a motion vector (MV) size are needed to determine the watermark embedding strength.

Simulation

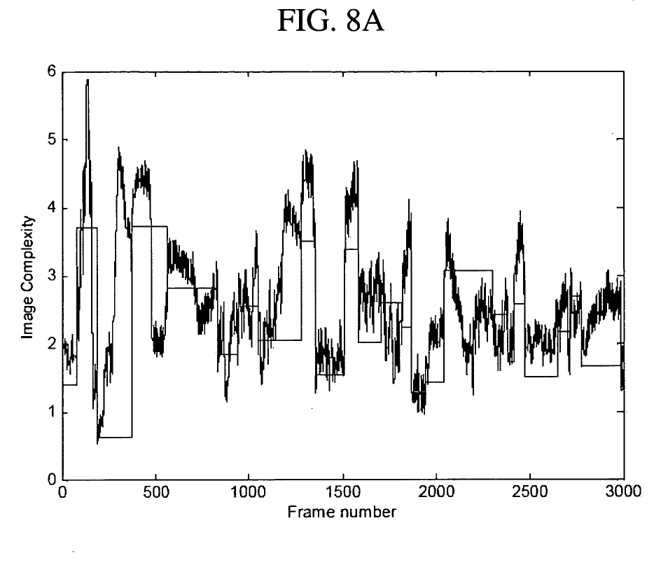

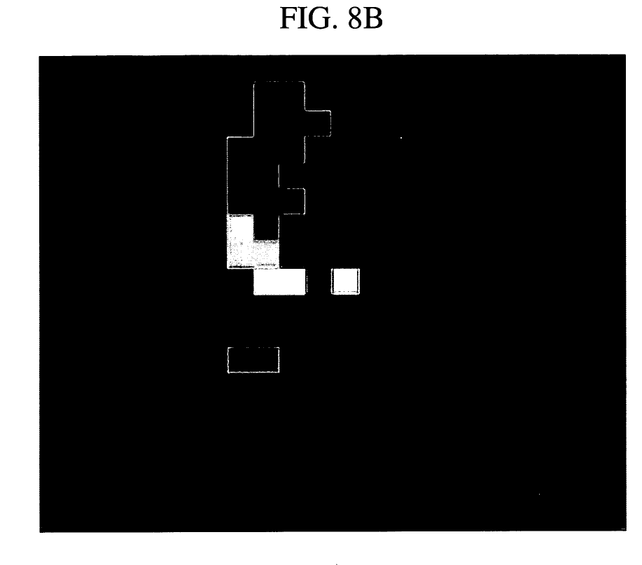

Simulation was performed to test performance of an exemplary embodiment of the present invention. The simulation was performed with respect to standard image sequences, i.e., a real broadcast video sequence. A simulated video sequence included 9 standard image sequences with 2309 frames having a size of 352×288. Images had been coded according to the MPEG-2 standard. The real broadcast video sequence included 3000 frames having a size of 320×240 that had been coded according to the MPEG-2 standard. FIG. 8A illustrates image complexity calculated using an AC coefficient. A lined plot indicates the first coefficient α. FIG. 8B illustrates areas defined according to a motion vector size. In FIG. 8B, four areas are defined according to the motion vector size. A larger motion vector defines a brighter area.

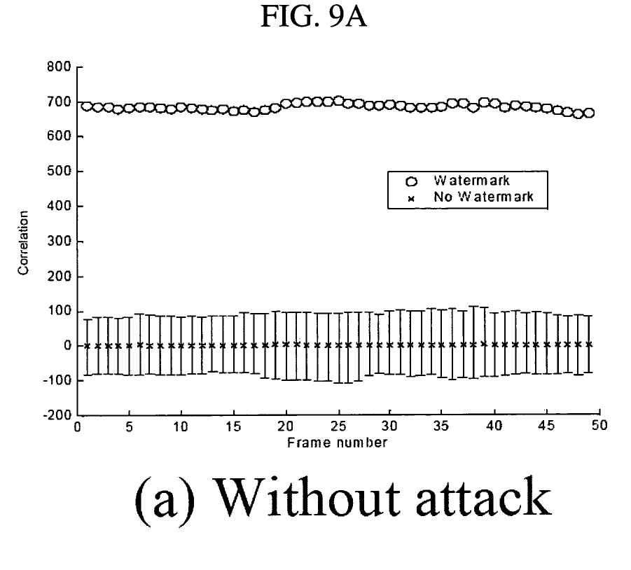

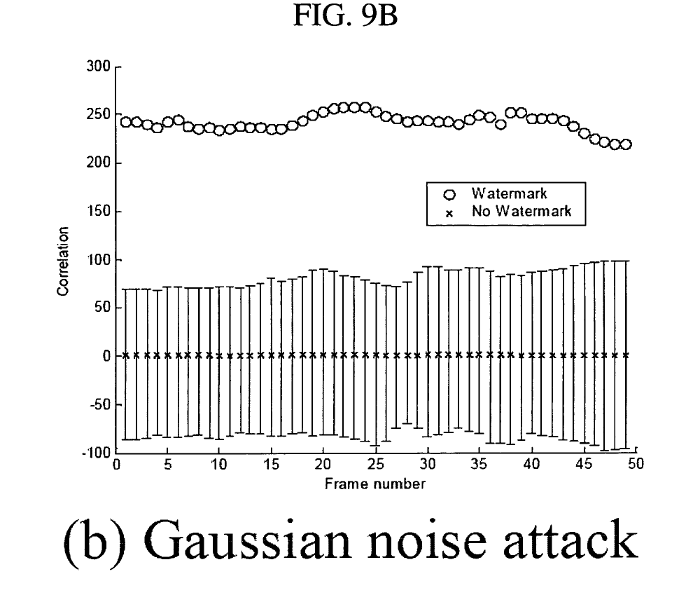

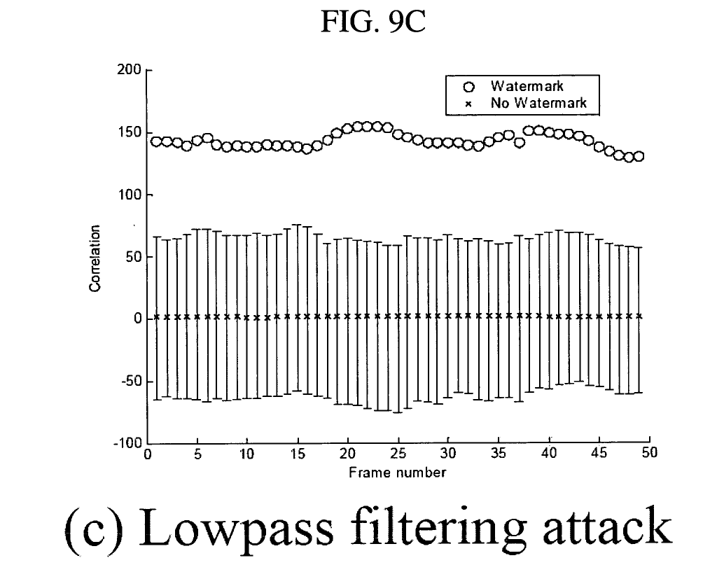

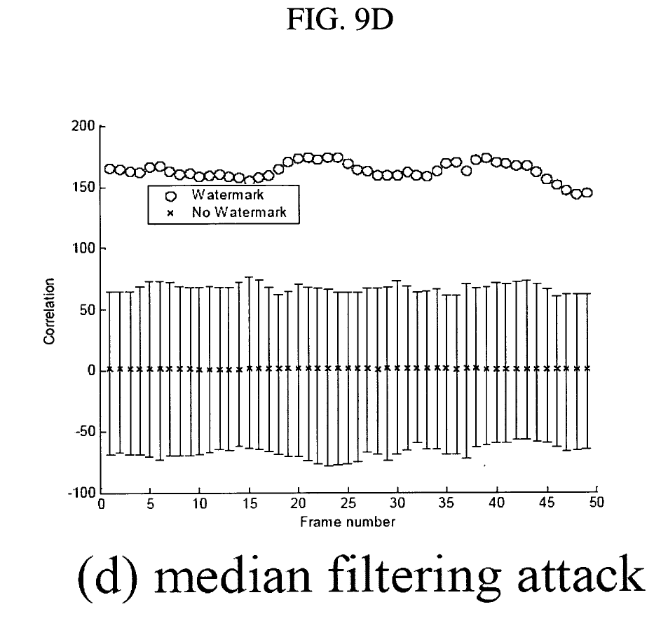

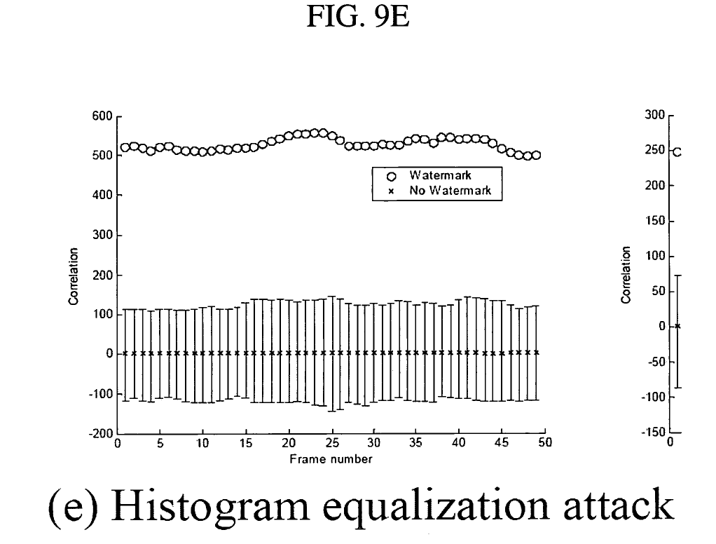

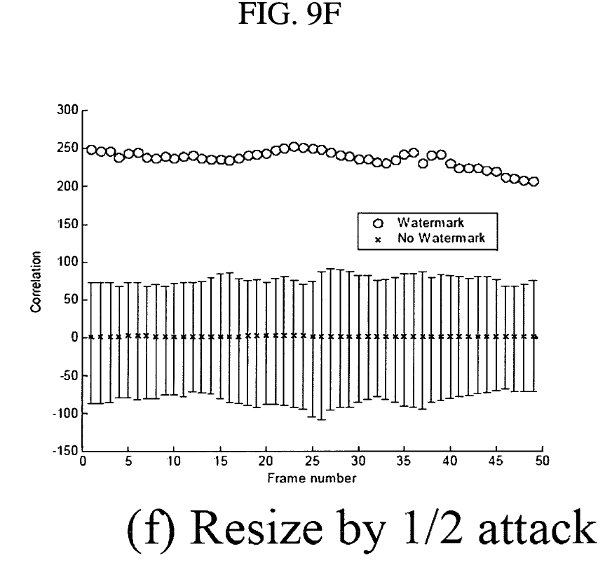

FIGS. 9A through 9F illustrate results of detecting a watermark according to an exemplary embodiment of the present invention when a watermarked image is attacked in various ways.

It will be understood by those of ordinary skill in the art that various changes in form and details may be made therein without departing from the spirit and scope of the present invention as defined by the following claims. Therefore, it is to be appreciated that the above described exemplary embodiment is for purposes of illustration only and not to be construed as a limitation of the invention. The scope of the invention is given by the appended claims, rather than the preceding description, and all variations and equivalents which fall within the range of the claims are intended to be embraced therein.

According to the present invention, since the amount of computation is small, real time video watermarking can be realized. In addition, a broadcast receiving unit and a video player that perform video content protection using a real time video watermarking technique can be manufactured.

1. A video watermarking method comprising:
detecting scene transition in a video sequence;
calculating an image complexity in a scene using at least one frame included in the scene and determining a watermark embedding strength for the scene; and
embedding a watermark into the scene according to the watermark embedding strength.

2. The video watermarking method of claim 1, wherein the at least one frame used to calculate the image complexity in the scene comprises a first intra-frame in the scene.

3. The video watermarking method of claim 2, wherein the image complexity is determined using alternating current (AC) coefficients in a discrete cosine transform (DCT) area.

4. The video watermarking method of claim 3, wherein the image complexity is determined as a sum of absolute values of among the AC coefficients.

5. The video watermarking method of claim 1, wherein when the image complexity exceeds a minimum image complexity, a coefficient used to determine the watermark embedding strength is determined by multiplying the image complexity by a predetermined constant; and
when the image complexity is equal to or less than the minimum image complexity, the coefficient is determined by multiplying the minimum image complexity by the predetermined constant.

6. The video watermarking method of claim 1, wherein the scene transition is determined according to a motion compensation direction in a macroblock type for a B-frame.

7. A video watermarking method comprising:
detecting scene transition in a video sequence;
calculating an image complexity in a scene using at least one frame included in the scene;
determining a first coefficient used to determine a first watermark embedding strength for the scene based on the image complexity;
determining a second coefficient used to determine a second watermark embedding strength according to a motion vector size of an inter-frame in the scene; and
embedding a watermark into intra-frames of the scene according to the first watermark embedding strength determined using the first coefficient and embedding the watermark into inter-frames of the scene according to the second watermark embedding strength determined using the first coefficient and the second coefficient.

8. The video watermarking method of claim 7, wherein the at least one frame used to calculate the image complexity in the scene comprises a first intra-frame in the scene.

9. The video watermarking method of claim 8, wherein the image complexity is determined using alternating current (AC) coefficients in a discrete cosine transform (DCT) area.

10. The video watermarking method of claim 9, wherein the image complexity is determined as a sum of absolute values of the AC coefficients.

11. The video watermarking method of claim 7, wherein when the image complexity exceeds a minimum image complexity, the first coefficient is determined by multiplying the image complexity by a predetermined constant; and
when the image complexity is equal to or less than the minimum image complexity, the first coefficient is determined by multiplying the minimum image complexity by the predetermined constant.

12. The video watermarking method of claim 7, wherein the second coefficient is determined for each of a plurality of areas defined according to the motion vector size of the inter-frame.

13. The video watermarking method of claim 7, wherein the scene transition is determined according to a motion compensation direction in a macroblock type for a B-frame.

14. The video watermarking method of claim 7, wherein the watermark is obtained by performing spectrum spreading on a watermark message using a watermark key.

15. A video watermarking apparatus comprising:
a scene transition detector which detects scene transition in a video sequence;
an image complexity calculator which calculates an image complexity in a scene using at least one frame included in the scene; and
a watermark embedder which determines a watermark embedding strength using the image complexity and embeds a watermark into the scene according to the watermark embedding strength.

16. The video watermarking apparatus of claim 15, wherein the watermark embedder determines the watermark embedding strength based on the image complexity and a motion vector size of an inter-frame in the scene and embeds the watermark into the scene according to the watermark embedding strength.

17. The video watermarking apparatus of claim 15, wherein the image complexity calculator calculates the image complexity in the scene using a first intra-frame in the scene.

18. The video watermarking apparatus of claim 17, wherein the image complexity is determined using alternating current (AC) coefficients in a discrete cosine transform (DCT) area.

19. The video watermarking apparatus of claim 18, wherein the image complexity is determined as a sum of absolute values of the AC coefficients.

20. The video watermarking apparatus of claim 17, wherein the image complexity is first image complexity and when the first image complexity exceeds a minimum image complexity, the image complexity calculator calculates a second image complexity by multiplying the first image complexity by a predetermined constant; and
when the first image complexity is equal to or less than the minimum image complexity, the first coefficient is determined by multiplying the minimum image complexity by the predetermined constant.

21. The video watermarking apparatus of claim 15, wherein the scene transition is determined according to a motion compensation direction in a macroblock type for a B-frame.

22. The video watermarking apparatus of claim 17, wherein the watermark embedder obtains the watermark to be embedded into the scene by performing spectrum spreading on a watermark message using a watermark key.

23. A video content protecting method comprising:
determining a watermark message to be included in a watermark according to an authorization for an input video sequence;
determining a watermark embedding strength for a scene included in the video sequence using an image complexity of a first intra-frame in the scene;
embedding a watermark into the scene according to the watermark embedding strength; and
detecting the watermark embedded in the scene and managing the video sequence according to the watermark message included in the watermark.

24. The video content protecting method of claim 23, wherein the determining of the watermark embedding strength comprises:
calculating the image complexity of the first intra-frame in the scene and determining a first coefficient using the image complexity;
determining a second coefficient based on a motion vector size of an inter-frame included in the scene;
determining a first watermark embedding strength using the first coefficient; and
determining a second watermark embedding strength using the first coefficient and the second coefficient; and
the embedding the watermark into the scene comprises embedding the watermark in each intraframe of the scene using the first watermark embedding strength and embedding the watermark in each inter-frame of the scene using the second watermark embedding strength.

25. The video content protecting method of claim 24, wherein the image complexity is determined using some coefficients among alternating current (AC) coefficients in a discrete cosine transform (DCT) area.

26. The video content protecting method of claim 23, wherein the scene transition is determined according to a motion compensation direction in a macroblock type for a B-frame.

27. The video content protecting method of claim 23, wherein the watermark is obtained by performing spectrum spreading on a watermark message using a watermark key.

28. A video content protecting apparatus comprising:
a message determiner which determines a watermark message to be included in a watermark according to an authorization on an input video sequence;
a watermark embedder which detects scene transition in the video sequence, determines a watermark embedding strength for a scene included in the video sequence using an image complexity of a first intra-frame in the scene, and embeds the watermark into the scene according to the watermark embedding strength;
a watermark detector which detects the watermark embedded in the scene; and
a video content management unit which manages the video sequence according to the watermark message included in the watermark.

29. The video content protecting apparatus of claim 28, wherein the watermark embedder calculates the image complexity of the first intra-frame in the scene to determine a first coefficient using the image complexity, determines a second coefficient based on a motion vector size of an inter-frame included in the scene, determines a first watermark embedding strength using the first coefficient for each intra-frame included in the scene, and determines a second watermark embedding strength using the first coefficient and the second coefficient for each intra-frame included in the scene.

30. The video content protecting apparatus of claim 28, further comprising a scene transition detector that detects scene transition in a video sequence according to a motion compensation direction in a macroblock type for a B-frame.

31. A recording medium having a program recorded therein to be readable by a computer, the program for causing the computer to execute the method of video watermarking, the method comprising:
detecting scene transition in a video sequence;
calculating an image complexity in a scene using at least one frame included in the scene and determining a watermark embedding strength for the scene; and
embedding a watermark into the scene according to the watermark embedding strength.

32. A recording medium having a program recorded therein to be readable by a computer, the program for causing the computer to execute the method of video watermarking, the method comprising:
detecting scene transition in a video sequence;
calculating an image complexity in a scene using at least one frame included in the scene;
determining a first coefficient used to determine a first watermark-embedding strength for the scene based on the image complexity;
determining a second coefficient used to determine a second watermark embedding strength according to a motion vector size of an inter-frame in the scene; and
embedding a watermark into intra-frames of the scene according to the first watermark embedding strength determined using the first coefficient and embedding the watermark into inter-frames of the scene according to the second watermark embedding strength determined using the first coefficient and the second coefficient.

33. A recording medium having a program recorded therein to be readable by a computer, the program for causing the computer to execute the method of protecting video content, the method comprising:
determining a watermark message to be included in a watermark according to an authorization for an input video sequence;
determining a watermark embedding strength for a scene included in the video sequence using an image complexity of a first intra-frame in the scene;
embedding a watermark into the scene according to the watermark embedding strength; and
detecting the watermark embedded in the scene and managing the video sequence according to the watermark message included in the watermark.
